(19) United States
(12) Patent Application Publication
(10) Pub. No.: US 2002/0156665 A1
(43) Pub. Date: Oct. 24, 2002

(54) Project cooperation supporting system

(76) Inventor: Akihiko Kakuta, Kanagawa (JP)

Correspondence Address: Gerald Levy, Pitney Hardin Kipp Szuch LLP, 685 Third Avenue, New York, NY, 10017-4024, US

(21) Appl. No.: 09/969,969

(22) Filed: Oct. 2, 2001

(30) Foreign Application Priority Data
Apr. 18, 2001 (JP) 2001-119055

(51) Int. Cl. G06F 17/60

(52) U.S. Cl. 705/7

(57) ABSTRACT

According to the conventional company cooperation method, it cannot be determined whether or not the companies can align with each other before the complicated and difficult process has finished, and thus vast amount of time and human resources needs for the realization of the alliance. In order to attain the above-mentioned object, the present invention is intended to provide a system for selecting the companies the most suitable for the project by a company evaluation result storing section for storing information of companies including venture companies by connecting it with the information of technologies that the companies have, and a project technology attaining section for attaining technologies necessary for the project, and when it is difficult to complete the project only by the selected companies, joining alliance partners having wide technical fields to the project.

### BACKGROUND OF THE INVENTION

This application claims priority of Japanese patent application no. 2001-119055, filed Apr. 18, 2001, and incorporated herein by reference.

1. Field of the Invention

The present invention relates to information processing technology for cooperation of a plurality of companies for implementing a project.

2. Description of the Related Art

Conventionally, the project based on a company alliance by a plurality of companies has needed complicated cooperation negotiation process based on interchange of key persons of the companies. The cooperation of a plurality of companies for a project thus essentially needs precise studies of technologies of the companies and the establishment of complimentary relationship among the companies. The process of the study, however, is terribly hard.

On the other hand, venture companies generally cannot receive the order of a project by themselves in spite of their unique and excellent technology, because there are very few projects completed by the technology that one venture company has.

The company that orders the project also hesitates to joint venture companies to the project due to the lack of social confidence.

### SUMMARY OF THE INVENTION

As described above, it cannot be determined according to the conventional company cooperation method whether or not the companies can align with each other before the complicated and difficult process has finished, and thus vast amount of time and human resources needs for the realization of the alliance.

On the other hand, venture companies generally have not a wide technical field and social confidence, and cannot easily receive an order of a project by themselves.

The present invention is intended to provide a system capable of reducing a number of steps necessary for evaluation of technologies of companies to participate a project and capable of easily joining venture companies as members of the project even if the companies have not a wide technical field and social confidence for completing the project by themselves.

In order to attain the above-mentioned object, the present invention is intended to provide a system for selecting the companies the most suitable for the project by a company evaluation result storing section for storing information of companies including venture companies by connecting it with the information of technologies that the companies have, and a project technology attaining section for attaining technologies necessary for the project, and when it is difficult to complete the project only by the selected companies, joining alliance partners having wide technical fields to the project.

With the above-mentioned system, the complicated process for aligning companies with each other can be simplified. Further, the project by small-scale companies such as venture companies can compensate the lack of technology and social confidence by joining the alliance partners to the project.

### BRIEF DESCRIPTION OF THE DRAWINGS

FIG. 1 is an explanatory view explaining the concept of a first embodiment.

FIG. 2 is a drawing as an example of a functional block diagram of the first embodiment.

FIG. 3 is a drawing as an example of the project information of the first embodiment.

FIG. 4 is a table as an example of the keyword extraction table of the first embodiment.

FIG. 5 is a table showing an example of the elementary technology information of the first embodiment.

FIG. 6 is a table as an example of the elementary technology information ID—company identifier table of the first embodiment.

FIG. 7 is a table showing an example of the concept of the business cooperation determination recording section of the first embodiment.

FIG. 8 is a flowchart as an example of the process flowchart of the first embodiment.

FIG. 9 is a drawing as an example of a functional block diagram of the second embodiment.

FIG. 10 is a table as an example of the elementary technology information ID—supplying cost—company identifier table of the second embodiment.

FIG. 11 is a flowchart as an example of the process flowchart of the second embodiment.

FIG. 12 is a drawing as an example of a functional block diagram of the third embodiment.

FIG. 13 is a table as an example of the elementary technology information ID—supplying cost—supplying time—company identifier table of the third embodiment.

FIG. 14 is a flowchart as an example of the process flowchart of the third embodiment.

FIG. 15 is a drawing as an example of a functional block diagram of the fourth embodiment.

FIG. 16 is a drawing showing an example of the concept of the elementary technology information of the fourth embodiment.

FIG. 17 is a flowchart as an example of the process flowchart of the fourth embodiment.

FIG. 18 is a drawing showing as an example of the relationship between alliance partners and cooperation determined companies according to the fourth embodiment.

FIG. 19 is a flowchart as an example of the business model of the fourth embodiment.

### DESCRIPTION OF THE PREFERRED EMBODIMENT

First Embodiment

The following is the detailed description of the first embodiment of the invention.

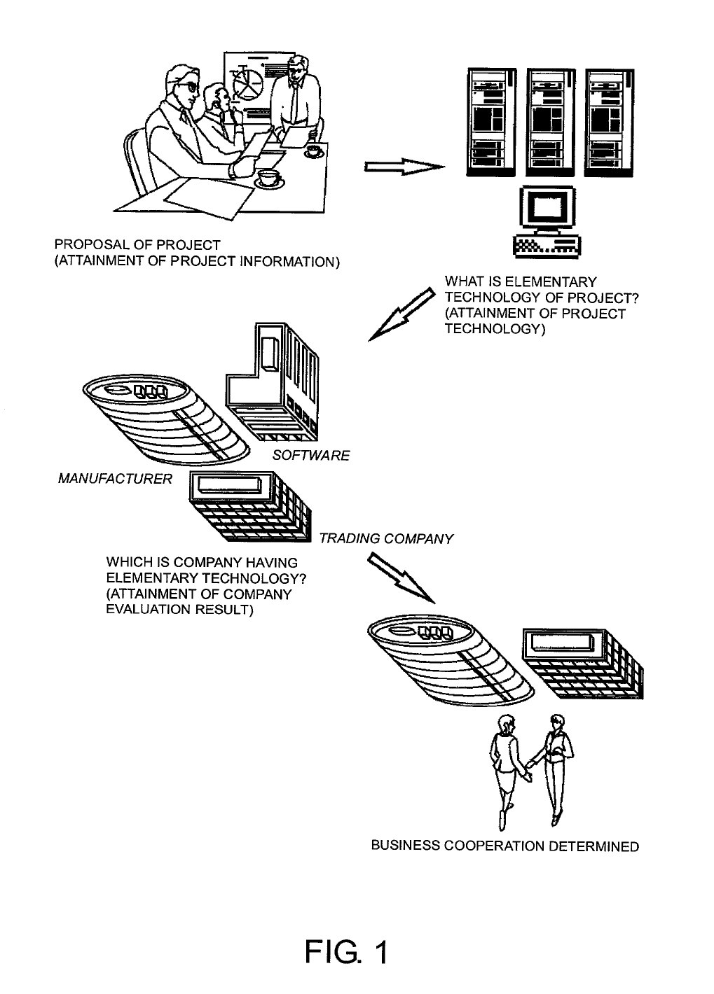

FIG. 1 is an explanatory view explaining the concept of the first embodiment. At first, the project is presented. The presentation of the project is offered by a client to the administrator or an owner of the project cooperation supporting system according to the first embodiment.

The project is offered in a form of an inquiry for example, that “can you program a ticket reservation system capable of being managed by ourselves?”.

With the project cooperation supporting system according to the present embodiment, the extraction (attainment) of the elementary technologies necessary for constituting the desired system is executed on the basis of the offer from the client at first. The selection of companies capable of providing the extracted elementary technologies, for example, venture companies having unique technologies is executed next. The companies practically joining the project are determined at last, and then recorded.

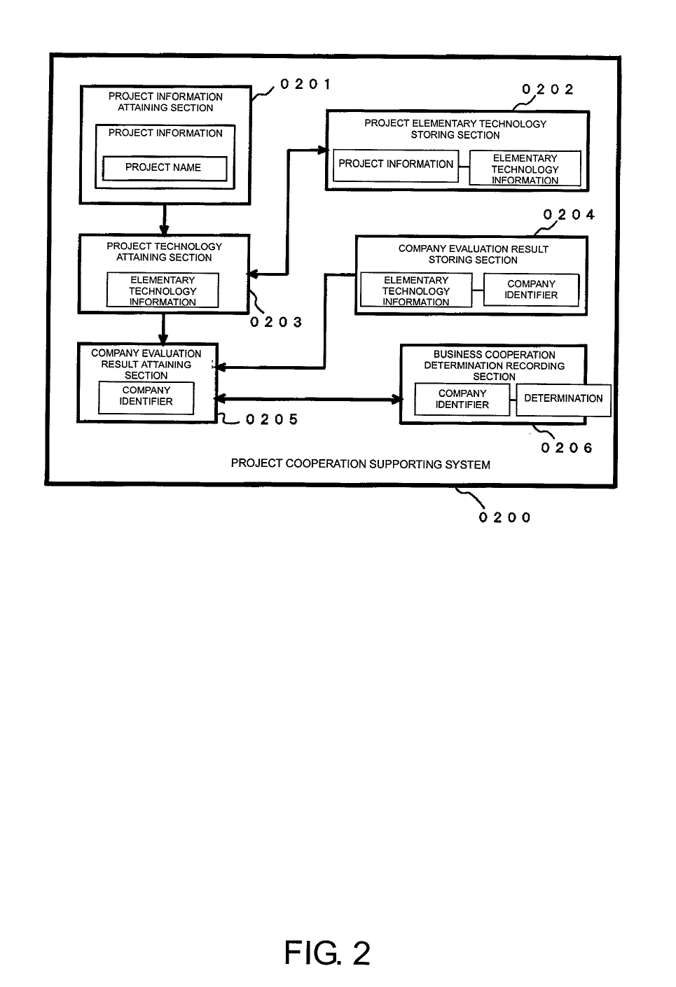

FIG. 2 is a drawing as an example of a functional block diagram of the system. The project cooperation supporting system 0200 of the present embodiment comprises a project information attaining section 0201, a project elementary technology storing section 0202, a project technology attaining section 0203, a company evaluation result storing section 0204, a company evaluation result attaining section 0205, and a business cooperation determination recording section 0206.

The project information attaining section 0201 attains project information including a project name.

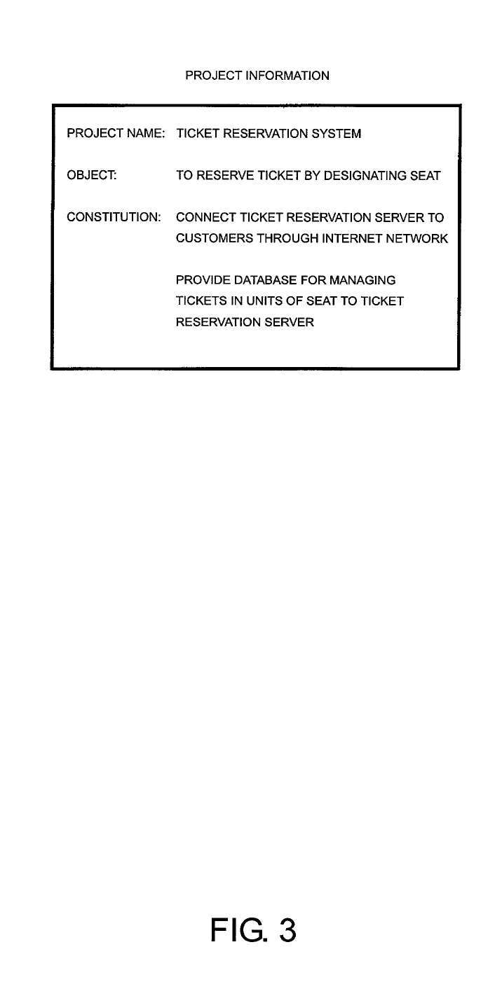

FIG. 3 is a drawing as an example of the project information of the first embodiment. As shown in the drawing, the project information includes the project name, the object, and the constitution necessary for executing the project. As described before, the project information attaining section is prepared on the basis of the offer of the program from the client, for example. One of the objects of the system is to determine a company group as the most suitable executive group of the offered project.

The project elementary technology storing section stores elementary technology information necessary for the project by connecting it with the project information. The project information is merely a description of the rough contents of the project, and intended to implement the elementary technology information necessary for executing the project with use of the elementary technology information stored in the project elementary technology storing section. The project elementary technology information storing section stores the elementary technology information attained in the past projects. It goes without saying that the elementary technology information based on the general information may be stored in the project elementary technology information storing section.

The project technology attaining section attains elementary technology information necessary for the project from the project elementary technology storing section on the basis of the project information attained by the project information attaining section.

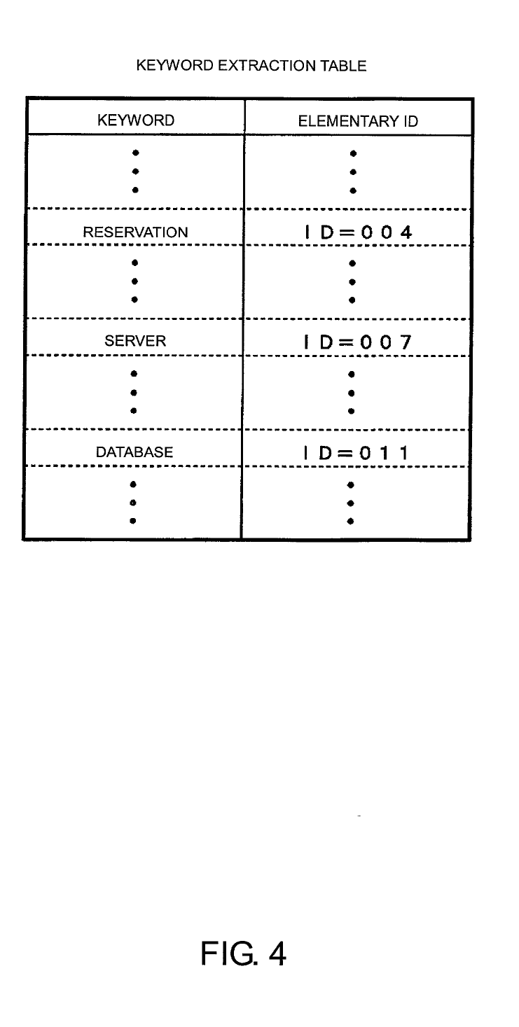

If the project information has the contents as shown in FIG. 3, the project information attaining section extracts the words “reservation”, “server”, and “database” as keywords, as shown in FIG. 4. Each of the keywords has a corresponding “elementary technology ID”, and the elementary technology IDs are connected to the “elementary technology information” in the project elementary technology storing section. For example, the keyword “reservation” is connected to “ID=004”, “server” is connected to “ID=007”, and “database” is connected to “ID=011”. In such a manner, the elementary technology IDs are connected to the “elementary technology information” in the project elementary technology storing section.

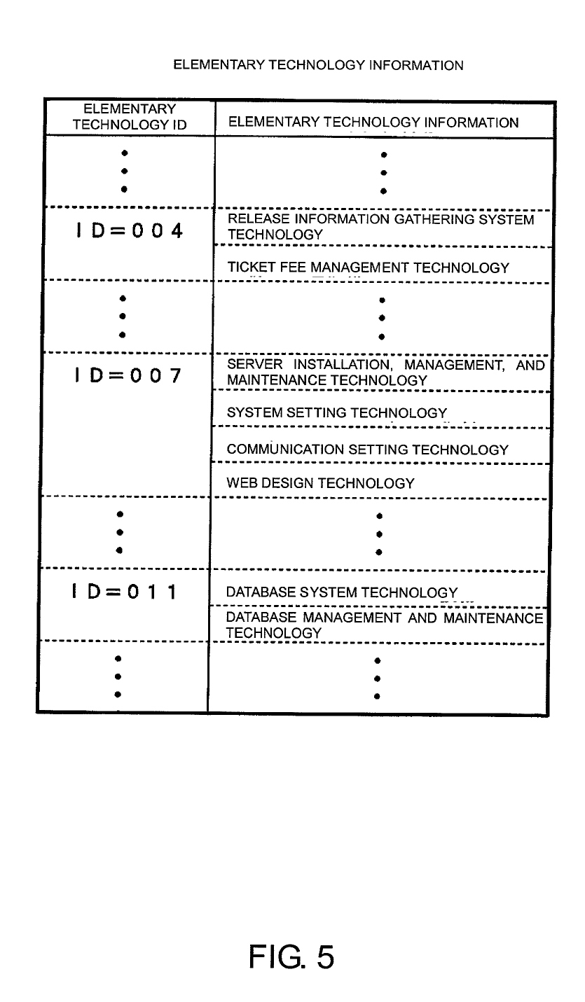

FIG. 5 shows an example of the connections of the “elementary technology IDs” and the “elementary technology information” in the project elementary technology storing section. For example, the elementary technology IDs “ID=004” is connected to the elementary technology information such as the elementary technologies “release information gathering system technology” and “ticket fee management technology”. In this time, one elementary technology IDs may be connected to one elementary technology or a plurality of elementary technology information.

The company evaluation result storing section stores company identifiers for identifying companies and the elementary technology information the companies can provide, by connecting them with each other. For example, venture companies having unique technologies are each designated one company identifier and connected to the elementary technology ID thereof. The information comprising the elementary technologies stored in the company evaluation result storing section and the company identifiers connected therewith may be attained from the performances of the past projects, or may be attained from the applications of the companies and the surveys of the applications and stored.

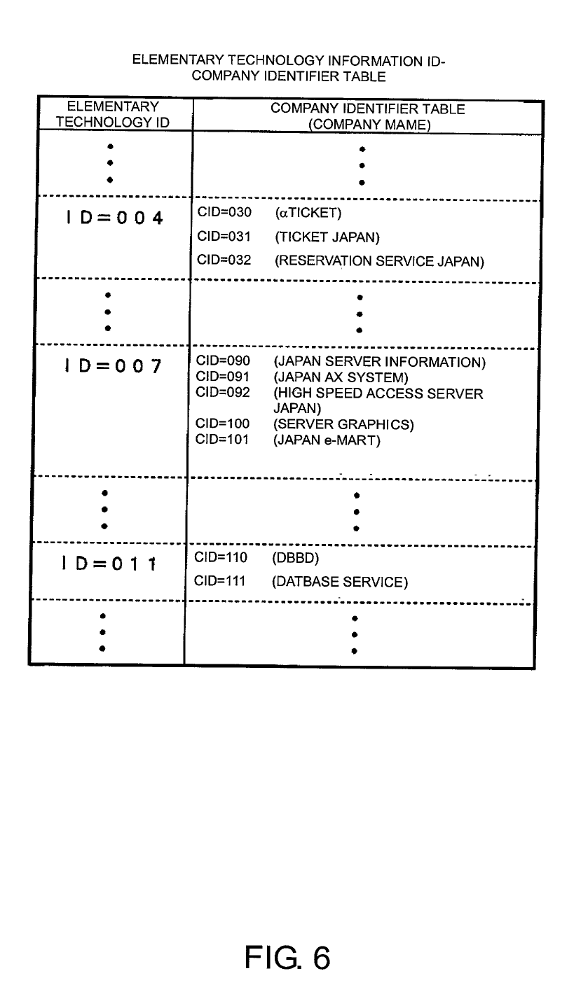

FIG. 6 is a table as an example of the elementary technology information ID—company identifier table in the company evaluation result storing section. For example, the elementary technology ID “ID=004” is connected to the company identifiers (company name) “CID=030 (α ticket)”, “CID=031 (“Ticket Japan)”, and “CID=032 (Reservation Service Japan).

The elementary technology IDs “ID=004” is preferably connected to a large number of the companies connected by publicly inviting the companies to join the project. This is because, the larger the number of the companies, the more the reliability of the entire system will be improved. In publicly inviting the companies, it is recommendable for the administrator of the present system to use an Internet home page, and to survey whether or not the applying companies are suitable to be registered in the present system. If the companies are registered in the present system, the business opportunities will be increased even if the companies are venture companies. If the companies are venture companies, the companies may be required for the registration fee in registering them. The companies may be registered free of charge in the registration, and charged of the joining fee when the companies join to the project.

The company evaluation result attaining section attains company identifiers capable of supplying the elementary technology information necessary for the project from the company evaluation result storing section on the basis of the elementary technology information attained by the project technology attaining section. For example, when the elementary technology ID of the elementary technology necessary for the project is “ID=004”, as shown in FIG. 6, the companies stored in the company evaluation result storing section and having the company identifiers corresponding to this elementary technology are “CID=030 (α ticket)”, “CID=031 (Ticket Japan)”, and “CID=032 (Reservation Service Japan), and thus these company identifiers are attained by the company evaluation result attaining section attains company.

The business cooperation determination recording section records the determination to join to the project the companies identified by the company identifiers attained by the company evaluation result attaining section.

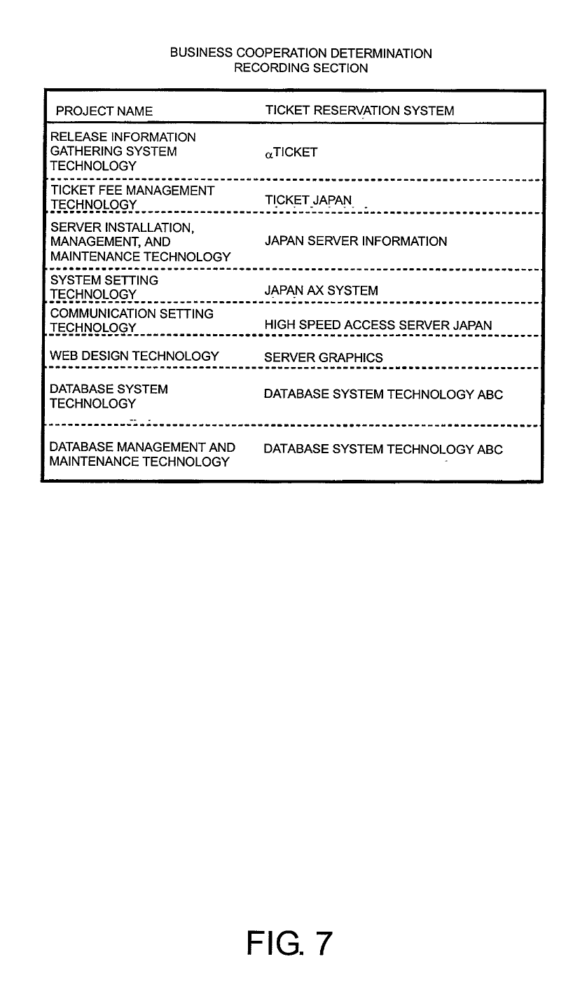

FIG. 7 is a table showing an example of the record by the business cooperation determination recording section. For example, the companies a ticket, and “Ticket Japan” are recorded for the elementary technologies identified in FIG. 6 by the elementary technology ID “ID=004” in the business cooperation determination recording section.

This determination does not always need to be executed merely in the technical point of view. The business alignment is connected to not only the technical problem but also to the financial problem and the social confidence. Only the companies (company identifiers) attained by the company evaluation result attaining section become the candidates to be recorded by the business cooperation determination recording section, and the other companies will not be the candidates. The business cooperation determination recording section, however, does not all the companies attained by the company evaluation result attaining section.

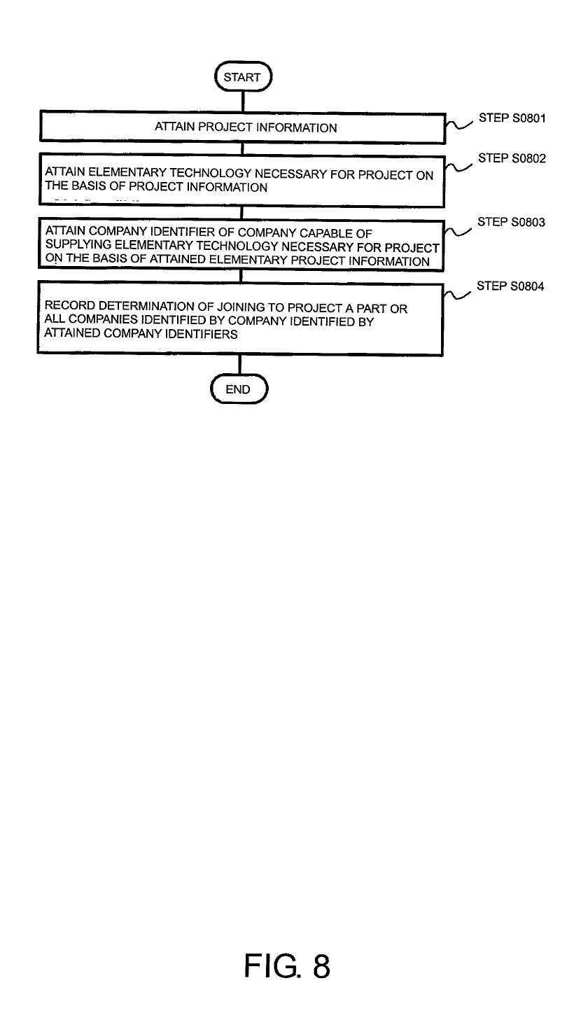

FIG. 8 is a flowchart showing the flow of this process according to the present embodiment. As shown in this flowchart, the project information is attained, at first (STEP S0801). Next, the elementary technology information necessary for the project is attained on the basis of the project information (STEP S0802). Subsequently, the company identifiers of the companies capable of supplying the elementary technology information necessary for the project is attained on the basis of the elementary technology information attained in the former step (STEP S0803). At the last of the process, the determination of joining to the project a part or all the companies identified by the company identifiers attained in the former step is recorded (STEP S0804).

The term “section” includes through all the present specification both a processing section driven by a practical circuit and a program for executing a specific function, and a process executed by the program, the practical circuit and the program.

Further, a “section” needs not to comprise a single physical structure, but a plurality of structures. Similarly, a plurality of “sections” may comprise a single structure, in fact. These will not to be repeated and the description thereof will be omitted in the following description. The procedures of the “processing” can be executed by a method, a program, and a medium in which the program is recorded. In the description of the “flow of the processing” of the present invention, the processing is described to be executed by any one of the three factors, and not limited to only one of these three factors. This will not be repeated in the following description for avoiding the redundancy.

Second Embodiment

The following is the detailed description of the second embodiment of the invention.

The second embodiment is based on the first embodiment, and relates to the project cooperation supporting system wherein the company evaluation result storing section stores company identifiers for identifying companies, the elementary technology information the companies can supply, and the technology supplying cost by connecting them with each other, and the company evaluation result attaining section comprises a company selection means for automatically selecting company capable of supplying the elementary technology at the lowest cost when a plurality of companies can supply one necessary elementary technology.

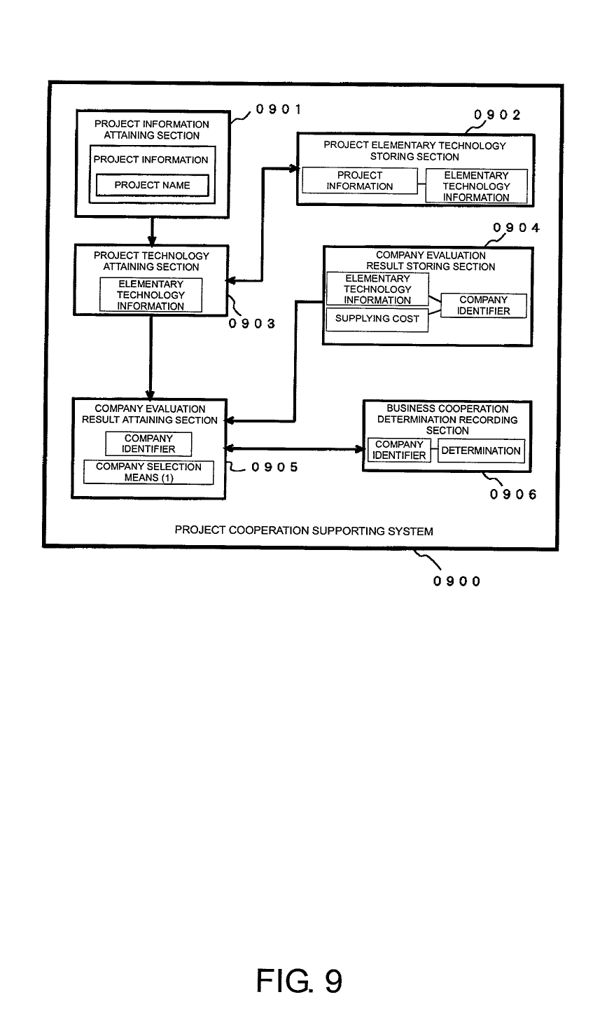

FIG. 9 is a drawing as an example of a functional block diagram of this system. The project cooperation supporting system 0900 of the present embodiment is the same as the system of the first embodiment in comprising a project information attaining section 0901, a project elementary technology storing section 0902, a project technology attaining section 0903, a company evaluation result storing section 0904, a company evaluation result attaining section 0905, and a business cooperation determination recording section 0906. The system of the present embodiment is characterized in that the company identifiers is connected not only to the elementary technologies, but also to the technology supplying cost in the company evaluation result storing section 0904. The “technology supplying cost” is the cost necessary to executing the elementary technology to implement the project. The cost needs to be described in a form by which the cost can be objectively evaluated, for example, the form using as a unit the processing amount that the elementary technology can process or working days necessary for the process.

The second feature of the project cooperation supporting system of the present embodiment is that the company evaluation result attaining section 0905 comprises the company selection means. The company selection means automatically selects the company capable of supplying the elementary technology at the lowest cost when a plurality of companies can supply one necessary elementary technology. Accordingly, the company evaluation result storing section needs to connect the company identifiers in a form by which the costs of the plurality of companies can be compared with each other.

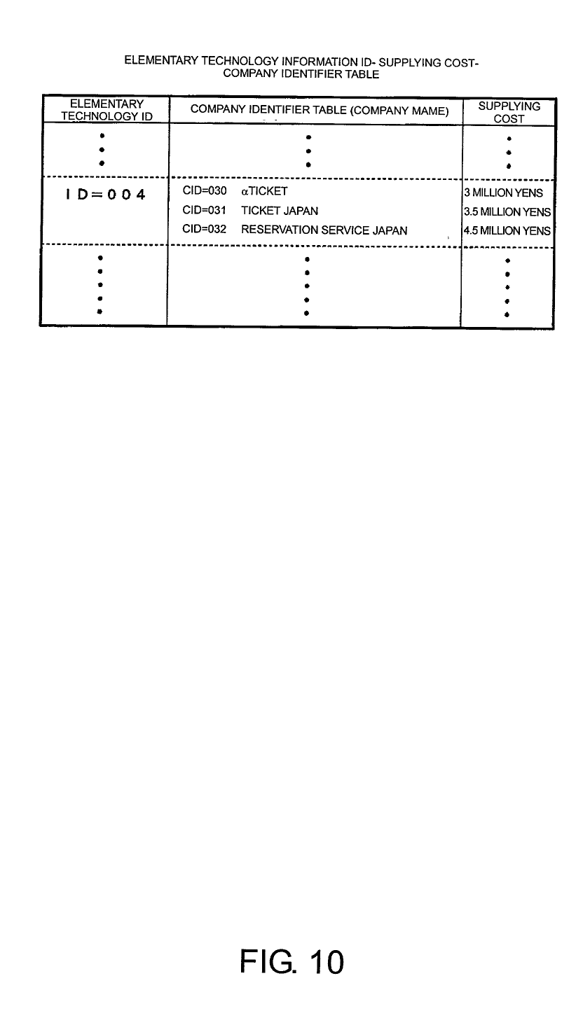

FIG. 10 is a table as an example of the elementary technology information ID—technology supplying cost—company identifier table described in the form by which the costs of the plurality of companies can be compared with each other. The table is stored in the company evaluation result storing section. For example, the elementary technology ID “ID=004” is connected to the company identifiers “CID=030 (α ticket)”, “CID=031 (“Ticket Japan)”, and “CID=032 (Reservation Service Japan). The technology supplying costs per one technology (the unit used here is “one technology”) supplied by the companies identified by the company identifiers are “3 million yens”, “3.5 million yens”, and “4.5 million yens” in order of amount. The company selection means selects the companies from that the technology supplying cost of which is the lowest, and the companies are selected in order of “CID=030 (α ticket)”, “CID=031 (“Ticket Japan)”, and “CID=032 (Reservation Service Japan). In accordance of the determined order, necessary number of the companies are selected: when two companies need to be selected, “CID=030 (α ticket)” and “CID=031 (“Ticket Japan)” are selected.

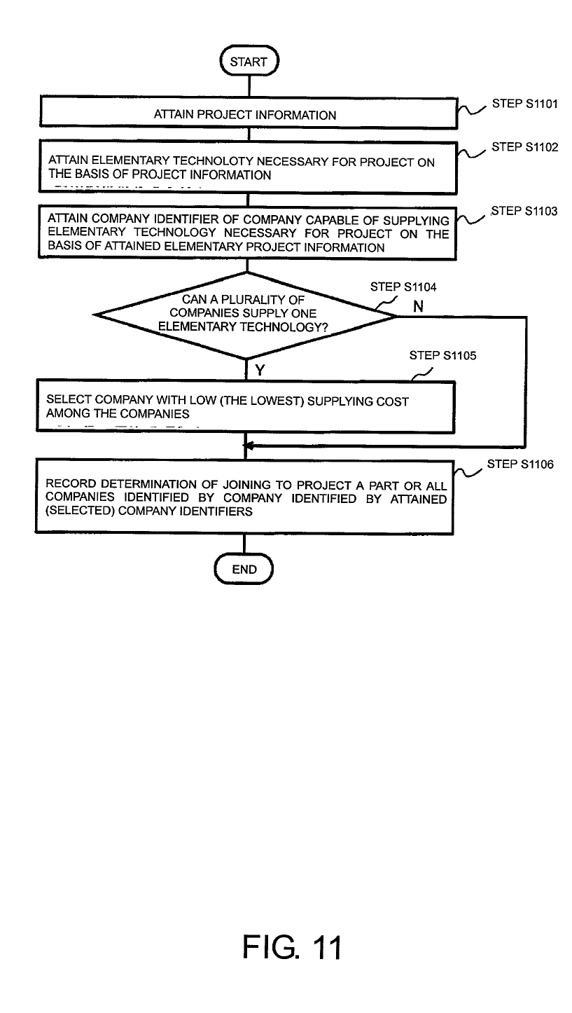

FIG. 11 is a flowchart showing the flow of the process according to the present embodiment. As shown in this flowchart, the project information is attained, at first (STEP S1101). Next, the elementary technology information necessary for the project is attained on the basis of the project information (STEP S1102). Subsequently, the company identifiers of the companies capable of supplying the elementary technology necessary for the project is attained on the basis of the elementary technology information attained in the former step (STEP S1103). It is then determined whether or not a plurality of companies can supply one elementary technology (STEP S1104). When a plurality of companies can not supply one elementary technology (there is only one company capable of supplying one elementary technology), the determination of joining to the project a part or all the companies identified by the company identifiers attained in the former step is recorded as in the last step of the first embodiment (STEP S1106).

When there are a plurality of determination results, a company the technology supplying cost of which is the lowest is selected from the plurality of companies (STEP S1105), and then the determination of joining to the project a part or all the companies identified by the company identifiers attained in the former step is recorded (STEP S1106).

Third Embodiment

The following is the detailed description of the third embodiment of the invention. The third embodiment is based on the first or second embodiment, and relates to the project cooperation supporting system wherein the company evaluation result storing section stores company identifiers for identifying companies, the elementary technologies the companies can supply, and the technology supplying cost by connecting them with each other, and the company evaluation result attaining section comprises a company selection means for automatically selecting company capable of supplying the elementary technology at the least time when a plurality of companies can supply one necessary elementary technology.

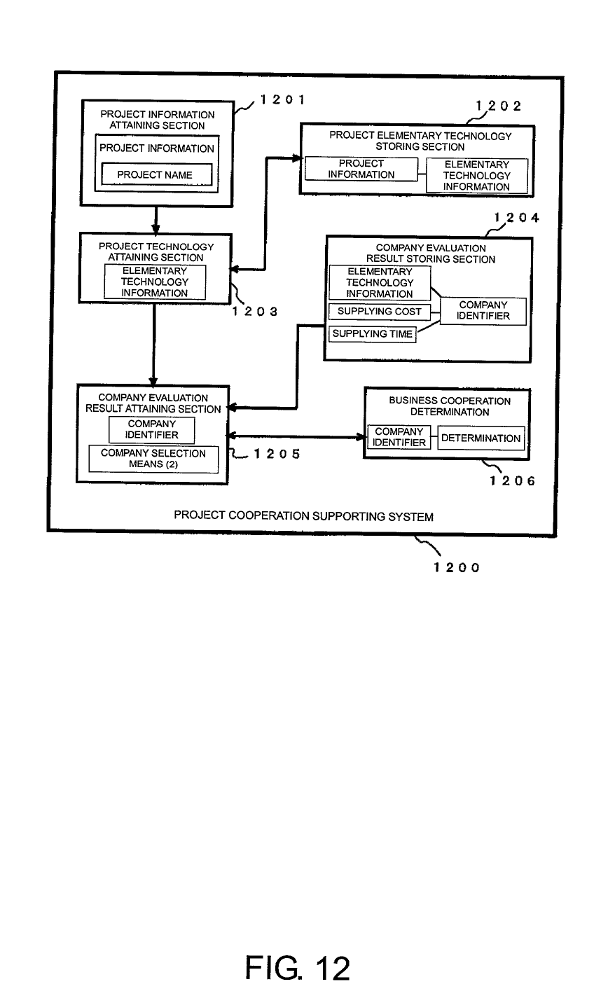

FIG. 12 is a drawing as an example of a functional block diagram of the system according to the present embodiment. As shown in this flowchart, the project cooperation supporting system 1200 of the present embodiment is the same as the system of the first or second embodiment in comprising a project information attaining section 1201, a project elementary technology storing section 1209, a project technology attaining section 1203, a company evaluation result storing section 1204, a company evaluation result attaining section 1205, and a business cooperation determination recording section 1206.

The system of the present embodiment is characterized in that the company identifiers is connected to the technology supplying time in the company evaluation result storing section 1204. The “technology supplying time” is the time necessary to executing the elementary technology to implement the project. The time needs to be described in a form by which the time can be objectively evaluated. For example, with use of the form based on the processing amount of the information that the elementary technology can process, a plurality of companies can be compared with each other. The units are “year, month, week, day, hour, minute” or the like.

The second feature of the project cooperation supporting system of the present embodiment is that the company evaluation result attaining section 1205 comprises the company selection means. In order to avoid the confusion with the company selection means of the second embodiment, it is denoted as “company selection means (2)” in the drawing. The company selection means automatically selects the company capable of supplying the elementary technology at the least time when a plurality of companies can supply one necessary elementary technology. Accordingly, the company evaluation result storing section 1200 needs to connect the company identifiers in a form by which the times of the plurality of companies can be compared with each other.

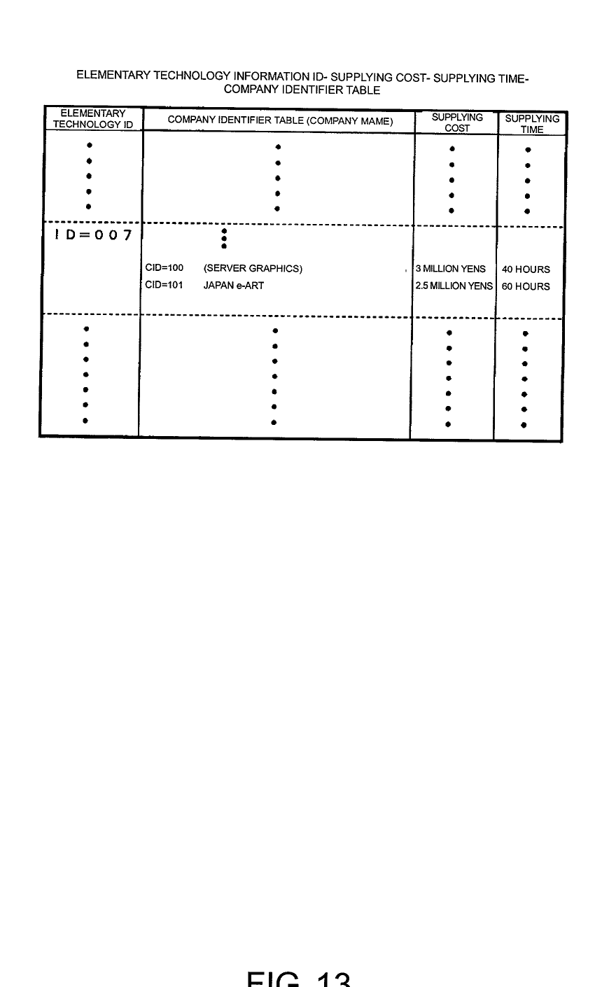

FIG. 13 is a table as an example of the elementary technology information ID technology supplying cost—technology supplying time—company identifier table described in the form by which the times of the plurality of companies can be compared with each other. The table is stored in the company evaluation result storing section. For example, the elementary technology ID “ID=007” is connected to the company identifiers “CID=100 (Server Graphics)” and “CID=101 (Japan e Art)”. The technology supplying times per one technology (the unit used here is “one technology”) supplied by the companies identified by the company identifiers are “40 hours” and “60 hours” in order of time length. The company selection means selects the companies from that the technology supplying time of which is the least, and the companies are selected in order of “CID=100 (Server Graphics)” and “CID=101 (Japan e Art)”. In accordance of the determined order, necessary number of the companies are selected: when one company needs to be selected, “CID=100 (Server Graphics)” is selected.

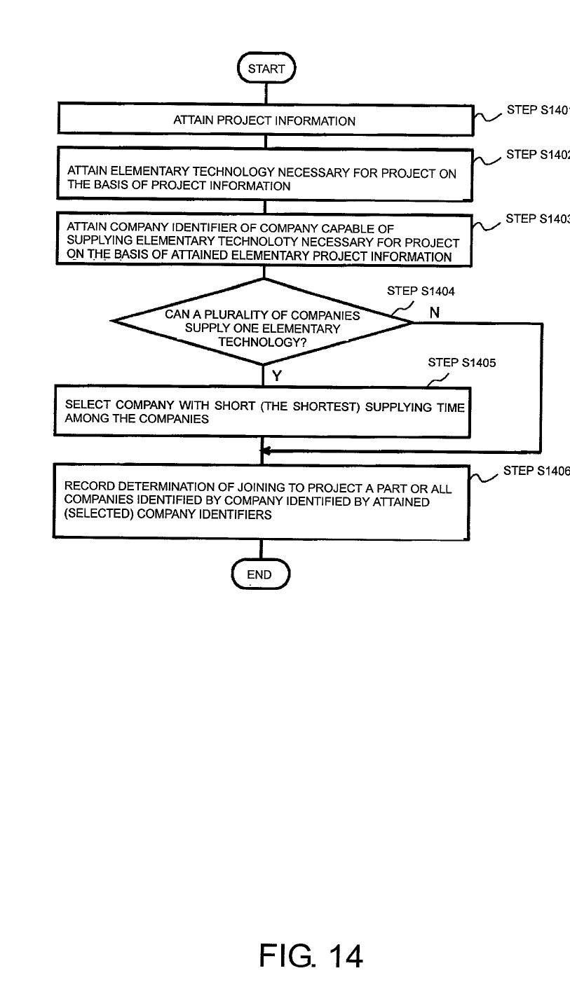

FIG. 14 is a flowchart showing the flow of the process according to the present embodiment. As shown in this flowchart, the project information is attained, at first (STEP S1401). Next, the elementary technology information necessary for the project is attained on the basis of the project information (STEP S1402). Subsequently, the company identifiers of the companies capable of supplying the elementary technology information necessary for the project is attained on the basis of the elementary technology information attained in the former step (STEP S1403). It is then determined whether or not a plurality of companies can supply one elementary technology (STEP S1404). When a plurality of companies can not supply one elementary technology (there is only one company capable of supplying one elementary technology), the determination of joining to the project a part or all the companies identified by the company identifiers attained in the former step is recorded as in the last step of the first embodiment (STEP S1406).

When there are a plurality of determination results, a company the technology supplying cost of which is the lowest is selected from the plurality of companies (STEP S1405), and then the determination of joining to the project a part or all the companies identified by the company identifiers attained in the former step is recorded as in the last step of the first embodiment (STEP S1406).

Fourth Embodiment

The following is the detailed description of the fourth embodiment of the invention. The system of the fourth embodiment is presented for executing the process necessary for the case where only the companies recorded by the business cooperation determination recording section cannot supply all the technologies necessary for realizing the project. More specifically, specific companies called as alliance partners supply the lacked technology and add to the project the social confidence and the like.

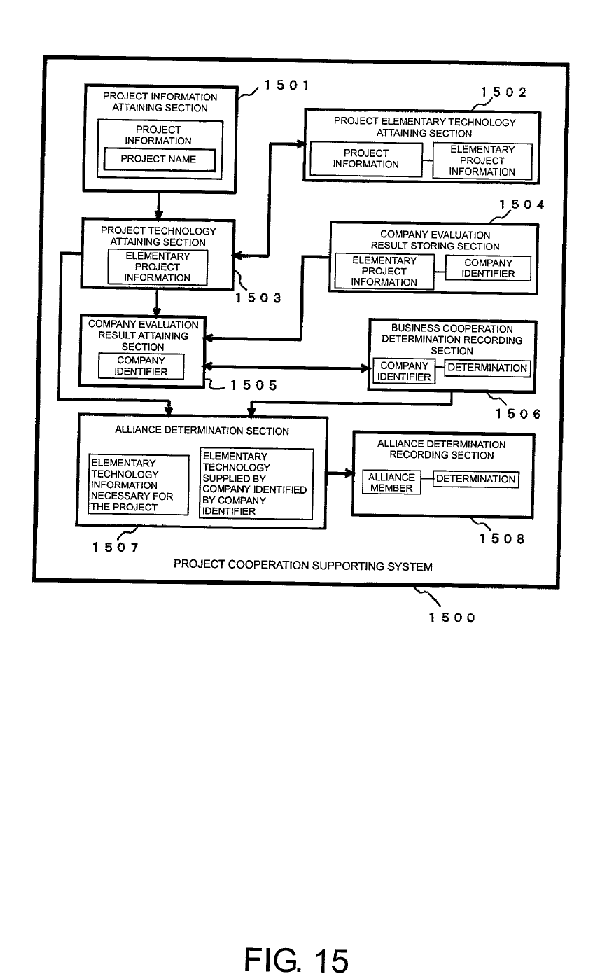

FIG. 15 is a drawing as an example of a functional block diagram of the project cooperation supporting system according to the present embodiment. The project cooperation supporting system 1500 of the present embodiment is the same as the system of the first, second or third embodiment in comprising a project information attaining section 1501, a project elementary technology storing section 1509, a project technology attaining section 1503, a company evaluation result storing section 1504, a company evaluation result attaining section 1505, and a business cooperation determination recording section 1506.

The system of the present embodiment is characterized by further comprising an alliance determination section 1507 and an alliance determination recording section 1508.

The project of the present embodiment is further characterized in that a project planner and alliance members as partners of the project planner cooperate to implement the project. This is because, the alliance partners supply the technology elementary lacked to the project.

Further, the present system selects as the alliance members relatively large-scale companies, in other words, the companies abundant in funds, technical fields, and social confidence. By joining such companies to the project, the project will enjoy high the social confidence.

The alliance determination section 1507 determines whether or not all the elementary technologies necessary for the project, which are attained by the project technology attaining section, can be supplied by the elementary technologies that can be supplied by the companies identified by the identifiers determined by the business cooperation determination recording section 1506. For example, when simple technology elements are supported by the companies recorded by the business cooperation determination recording section such as the venture companies but no company functions as a customer support center, the alliance determination section determines that all the elementary technologies necessary for the project cannot be supplied by the companies identified by the identifiers determined by the business cooperation determination recording section 1506.

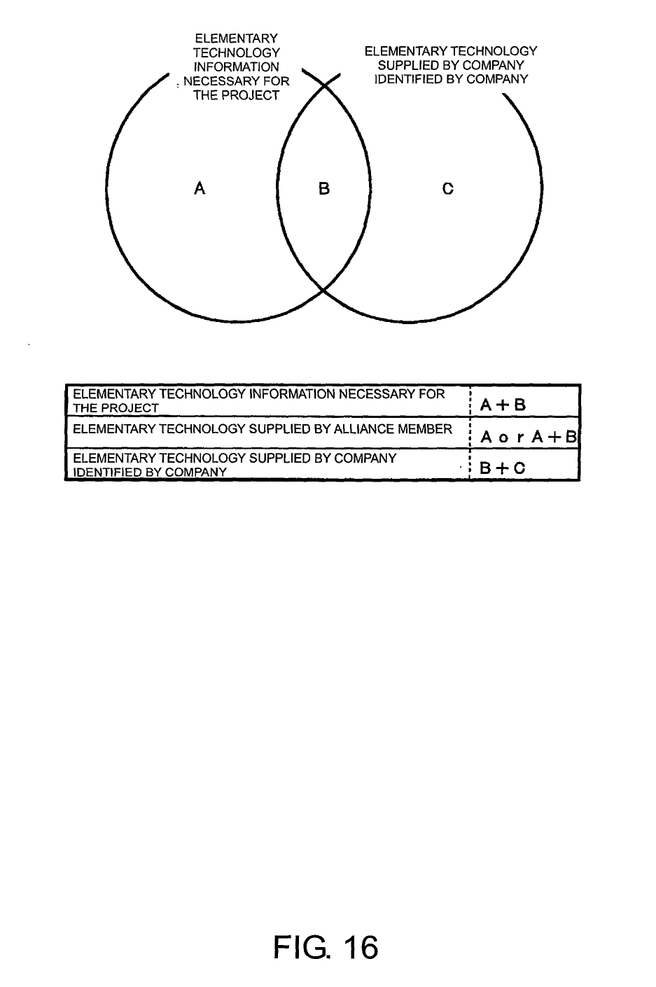

FIG. 16 shows the relationship between the elementary technologies necessary for the project and the elementary technologies that can be supplied by the companies identified by the identifiers. The alliance determination section determines whether or not all the elementary technologies “A+B” necessary for the project are included in the elementary technologies that can be supplied by the companies identified by the identifiers. When “A+B”=“B”, all the elementary technologies “A+B” necessary for the project are included in the elementary technologies that can be supplied by the cooperating companies, and no alliance member joins to the project.

When “A+B” does not equal to “B”, more specifically, when the elementary technologies “A” cannot supplied by the cooperating companies, it is determined to join alliance members to the project.

The alliance determination recording section records the determination to join the alliance members when the alliance determination section determines that a part of the elementary technologies necessary for the project, which are attained by the project technology attaining section, cannot be satisfied by the elementary technologies that can be supplied by the companies identified by the identifiers determined by the business cooperation determination recording section.

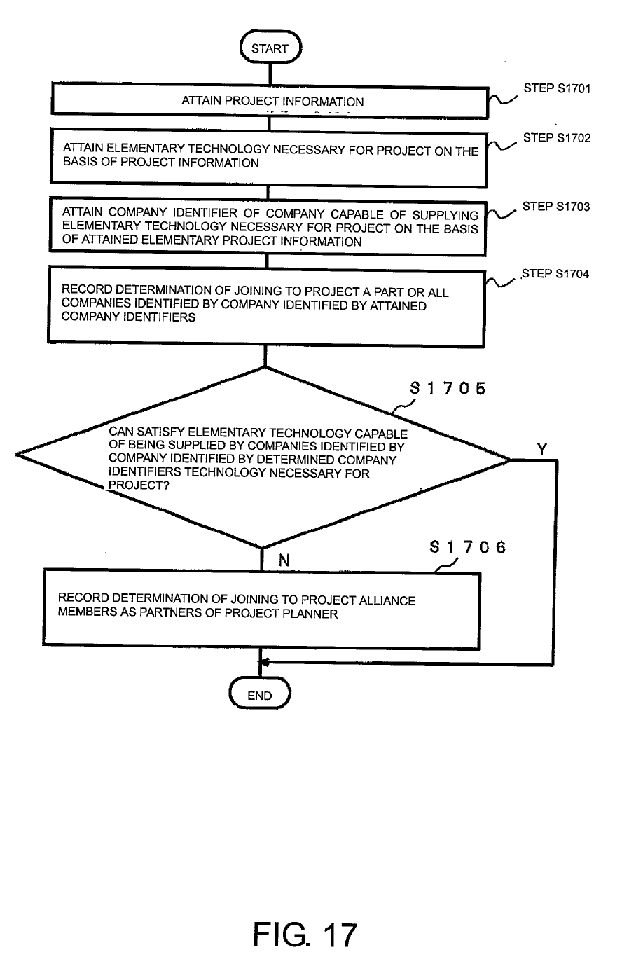

FIG. 17 is a flowchart showing the flow of the process according to the present embodiment. As shown in this flowchart, the project information is attained, at first (STEP S1701). Next, the elementary technology information necessary for the project is attained on the basis of the project information (STEP S1702). Subsequently, the company identifiers of the companies capable of supplying the elementary technology necessary for the project is attained on the basis of the elementary technology information attained in the former step (STEP S1703). After the step, the determination of joining to the project a part or all the companies capable of supplying the elementary technology information necessary for the project is recorded (STEP S1704). It is then determined whether or not the elementary technologies necessary for the project can be supplied by the elementary technologies that can be supplied by the companies identified by the identifiers determined in the former step (STEP S1705). When the elementary technologies can be supplied by the companies, the process will be ended. When the elementary technologies cannot be supplied by the companies, the business cooperation determination recording section records the determination of joining to the project the alliance members as partners of the project planner (STEP S1706).

The “alliance members as partners of the project planner” means the members always ready for joining the project to support the project offered by the client to use the project cooperation supporting system. The members are referred to as “partners”, but need not to be judicially equal thereto, but may be parent companies or subcontractors. The members need to intend to cooperate each other for the management of the project cooperation supporting system and thus are preferable to be large-scale companies abundant in funds and social confidence.

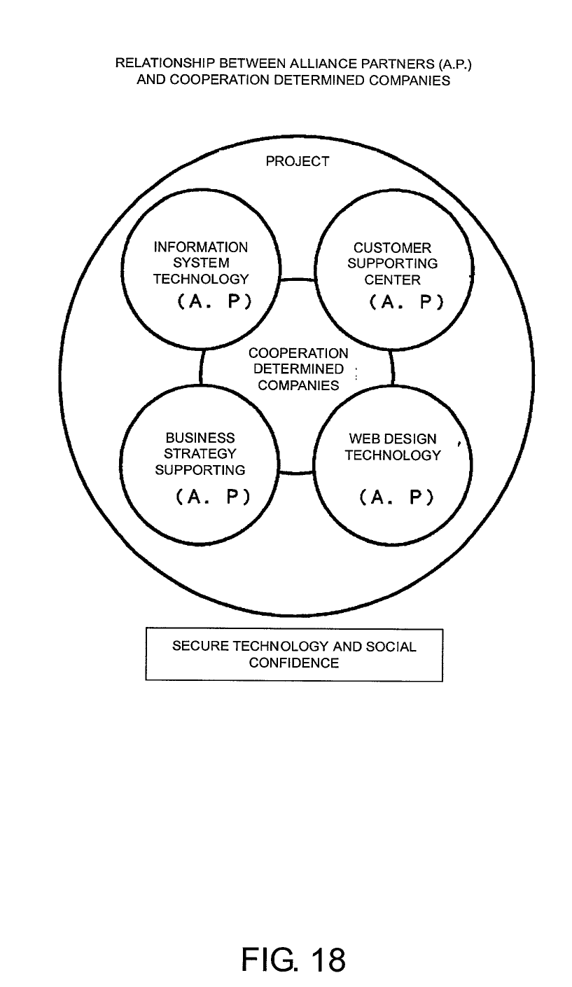

FIG. 18 shows the relationship between the cooperation determined companies and the alliance partners. For example, the alliance member which is the large-scale companies are excellent in “information system technology”, “customer support center function”, “business strategy supporting”, and “WEB design technology” cooperate as the alliance partners.

As shown in the drawing, the project will be expected to have or enhance high technology and social confidence by joining the alliance companies to the project. Accordingly, the excellent technologies of the conventional venture companies, which have been utilized for a society due to narrow technical field and poor funds and social confidence, can be utilized with this system.

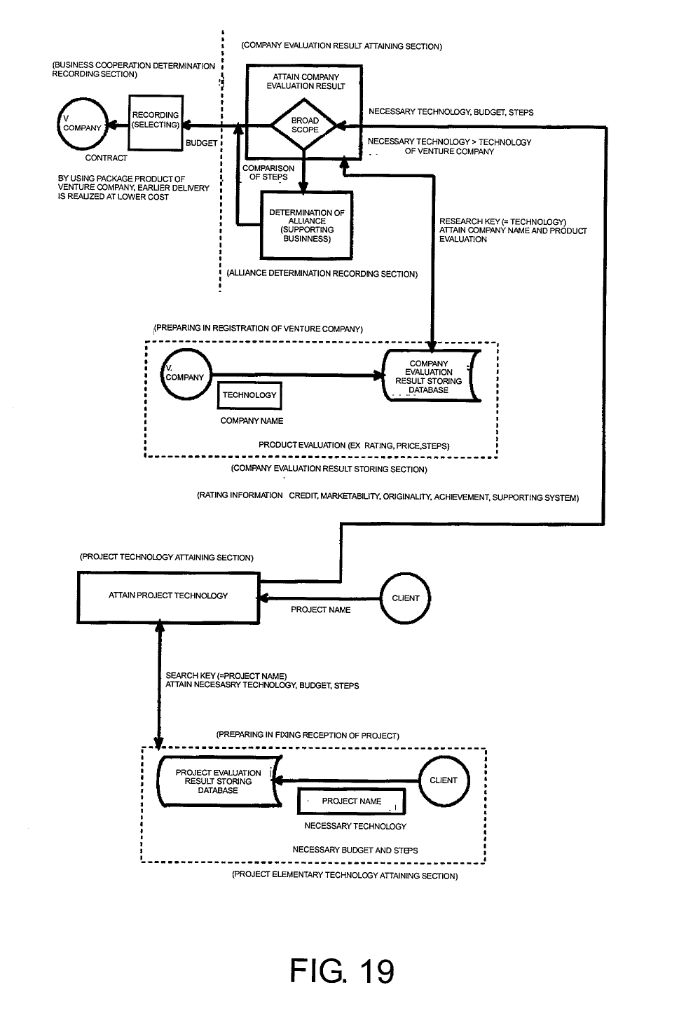

FIG. 19 is a flowchart as an example of the business model of the present embodiment. As shown in the chart, the project technology attaining section attains the project technologies (including elementary technology information, project information, and the like) such as technologies, budget, and the number of steps necessary for the project from the project elementary technology storing section (the section has a project evaluation result storing database) on the basis of the project information (it may be merely a project name, for example) offered by the client.

When the reception of the project is surely determined, the project technologies of the project to be received is stored in the project evaluation result storing database.

On the basis of the attained project technologies, the company evaluation result attaining section searches the corresponding companies in the company evaluation result storing section.

Concerning the searched companies, the information such as company rating (rating information), prices of the products distributed by the company, the number of the steps for incorporating the products into the project, and the like can be attained.

The “rating information” is the rating of the confidentiality based on credit, marketability, originality, achievement, and supporting system, or the like. The company stored in the company evaluation result storing database of the company evaluation result storing section may store the publicly invited and registered venture companies, as described before.

It is then determined whether or not the elementary technologies supplied by the companies satisfy the elementary technologies necessary for the project. When the elementary technologies supplied by the companies do not satisfy the elementary technologies necessary for the project, the project to which the alliance members join will be started.

By aligning with the venture companies in this manner, the alliance members enjoy such merits that the technologies the alliance members do not have will be supplied by the venture companies or the like, and that the project that cannot be received by the alliance members alone who cannot receive projects at low cost can be received.

According to the present invention, the complicated process for aligning companies with each other can be simplified. Further, the project by small-scale companies such as venture companies can compensate the lack of technology and social confidence by joining the alliance partners to the project.

To sum up, with use of the system of the present invention, excellent technologies of the small-scale companies such as venture companies can be widely utilized for the society.

What is claimed is:

1. A project cooperation supporting system, comprising:
a project information attaining section for attaining project information including a project name;
a project elementary technology storing section for storing elementary technology information necessary for a project such that the elementary technology information is connected to the project information;
a project technology attaining section for attaining elementary technology information necessary for the project from the project elementary technology storing section on the basis of the project information attained by the project information attaining section;
a company evaluation result storing section for storing company identifiers for identifying companies and the elementary technologies the companies can supply such that the company identifiers and the elementary technologies are connected with each other;
a company evaluation result attaining section for attaining company identifiers capable of supplying the elementary technology information necessary for the project from the company evaluation result storing section on the basis of the elementary technology information attained by the project technology attaining section; and
a business cooperation determination recording section for recording determination to join to the project the companies identified by the company identifiers attained by the company evaluation result attaining section.

2. A project cooperation supporting system according to claim 1, wherein the company evaluation result storing section stores company identifiers for identifying companies, the elementary technology information the companies can supply, and the technology supplying cost such that the company identifiers, the elementary technologies, and the technology supplying cost are connected with each other, and
the company evaluation result attaining section comprises a company selection means for automatically selecting company capable of supplying the elementary technology at the lowest cost when a plurality of companies can supply one necessary elementary technology.

3. A project cooperation supporting system according to claim 1, wherein the company evaluation result storing section stores company identifiers for identifying companies, the elementary technology information the companies can supply, the technology supplying cost, and the technology supplying time such that the company identifiers, the elementary technologies, the technology supplying cost, and the technology supplying time are connected with each other, and
the company evaluation result attaining section comprises a company selection means for automatically selecting company capable of supplying the elementary technology at the least time when a plurality of companies can supply one necessary elementary technology.

4. A project cooperation supporting system according to claim 2, wherein the company evaluation result storing section stores company identifiers for identifying companies, the elementary technology information the companies can supply, the technology supplying cost, and the technology supplying time such that the company identifiers, the elementary technologies, the technology supplying cost, and the technology supplying time are connected with each other, and
the company evaluation result attaining section comprises a company selection means for automatically selecting company capable of supplying the elementary technology at the least time when a plurality of companies can supply one necessary elementary technology.

5. A project cooperation supporting system for a project implemented by a project planner and alliance members as partners of the project planner, comprising:
a project information attaining section for attaining project information including a project name;
a project elementary technology storing section for storing elementary technology information necessary for a project such that the elementary technology information is connected to the project information;
a project technology attaining section for attaining elementary technology information necessary for the project from the project elementary technology storing section on the basis of the project information attained by the project information attaining section;
a company evaluation result storing section for storing company identifiers for identifying companies and the elementary technology information the companies can supply such that the company identifiers and the elementary technology information are connected with each other;
a company evaluation result attaining section for attaining company identifiers capable of supplying the elementary technology necessary for the project from the company evaluation result storing section on the basis of the elementary technology information attained by the project technology attaining section;
a business cooperation determination recording section for recording determination to join to the project the companies identified by the company identifiers attained by the company evaluation result attaining section;
an alliance determination section for determining whether or not all the elementary technologies necessary for the project, which are attained by the project technology attaining section, can be supplied by the elementary technologies that can be supplied by the companies identified by the identifiers determined by the business cooperation determination recording section; and
an alliance determination recording section for recording determination to join alliance members unless the alliance determination section determines that a part of the elementary technologies necessary for the project, which are attained by the project technology attaining section, can be satisfied by the elementary technologies that can be supplied by the companies identified by the identifiers determined by the business cooperation determination recording section.

6. A project cooperation supporting method comprising the steps of:
attaining project information;
attaining elementary technology information necessary for a project on the basis of the project information;
attaining company identifiers capable of supplying the elementary technology necessary for the project on the basis of the elementary technology information attained in the former step; and
recording determination to join to the project at least a part of the companies identified by the company identifiers attained in the former step.

7. A project cooperation supporting method comprising the steps of:
attaining project information;
attaining elementary technology information necessary for a project on the basis of the project information;
attaining company identifiers capable of supplying the elementary technology necessary for the project on the basis of the elementary technology information attained in the former step;
determining whether or not a plurality of companies can supply one elementary technology, and recording determination to join to the project a part or all the companies identified by the company identifiers when there is only one company capable of supplying one elementary technology;
selecting company capable of supplying the elementary technology at the lowest cost from the plurality of companies when there are a plurality of determination results; and
recording determination to join to the project a part or all the companies identified by the company identifiers.

8. A project cooperation supporting method comprising the steps of:
attaining project information;
attaining elementary technology information necessary for a project on the basis of the project information;
attaining company identifiers capable of supplying the elementary technology necessary for the project on the basis of the elementary technology information attained in the former step;
determining whether or not a plurality of companies can supply one elementary technology, and recording determination to join to the project a part or all the companies identified by the company identifiers when there is only one company capable of supplying one elementary technology;
selecting company capable of supplying the elementary technology at the lowest cost from the plurality of companies when there are a plurality of determination results; and
recording determination to join to the project a part or all the companies identified by the company identifiers.

9. A project cooperation supporting system comprising the steps of:
attaining project information;
attaining elementary technology information necessary for a project on the basis of the project information;
attaining company identifiers capable of supplying the elementary technology necessary for the project on the basis of the elementary technology information attained in the former step;
recording determination to join to the project a part or all the companies identified by the company identifiers among one company capable of supplying one elementary technology;
determining whether or not the elementary technologies necessary for the project can be supplied by the elementary technologies that can be supplied by the companies identified by the identifiers determined in the former step; and
ending process when the elementary technologies necessary for the project can be supplied by the elementary technologies that can be supplied by the companies identified by the identifiers determined in the former step, and unless the elementary technologies necessary for the project can be supplied by the elementary technologies that can be supplied by the companies identified by the identifiers, recording determination to join alliance members as partners of a project planner.

10. A project cooperation supporting program for executing in a computer the steps of:
attaining project information;
attaining elementary technology information necessary for a project on the basis of the project information;
attaining company identifiers capable of supplying the elementary technology necessary for the project on the basis of the elementary technology information attained in the former step; and
recording determination to join to the project a part or all the companies identified by the company identifiers attained in the former step.

11. A project cooperation supporting program for executing in a computer the steps of:
attaining project information;
attaining elementary technology information necessary for a project on the basis of the project information;
attaining company identifiers capable of supplying the elementary technology necessary for the project on the basis of the elementary technology information attained in the former step;
determining whether or not a plurality of companies can supply one elementary technology, and recording determination to join to the project a part or all the companies identified by the company identifiers when there is only one company capable of supplying one elementary technology;
selecting company capable of supplying the elementary technology at the lowest cost from the plurality of companies when there are a plurality of determination results; and
recording determination to join to the project a part or all the companies identified by the company identifiers.

12. A project cooperation supporting program for executing in a computer the steps of:
attaining project information;
attaining elementary technology information necessary for a project on the basis of the project information;
attaining company identifiers capable of supplying the elementary technology necessary for the project on the basis of the elementary technology information attained in the former step;
determining whether or not a plurality of companies can supply one elementary technology, and recording determination to join to the project a part or all the companies identified by the company identifiers when there is only one company capable of supplying one elementary technology;
selecting company capable of supplying the elementary technology at the lowest cost from the plurality of companies when there are a plurality of determination results; and
recording determination to join to the project a part or all the companies identified by the company identifiers.

13. A project cooperation supporting program for executing in a computer the steps of:
attaining project information;
attaining elementary technology information necessary for a project on the basis of the project information;
attaining company identifiers capable of supplying the elementary technology necessary for the project on the basis of the elementary technology information attained in the former step;
recording determination to join to the project a part or all the companies identified by the company identifiers,
determining whether or not the elementary technologies necessary for the project can be supplied by the elementary technologies that can be supplied by the companies identified by the identifiers determined in the former step; and
ending process when the elementary technologies necessary for the project can be supplied by the elementary technologies that can be supplied by the companies identified by the identifiers determined in the former step, and unless the elementary technologies necessary for the project can be supplied by the elementary technologies that can be supplied by the companies identified by the identifiers, recording determination to join alliance members as partners of a project planner.
